(19) United States
(12) Patent Application Publication
(10) Pub. No.: US 2016/0251769 A1
(43) Pub. Date: Sep. 1, 2016

(54) THERMAL INTERFACE MATERIALS USING METAL NANOWIRE ARRAYS AND SACRIFICIAL TEMPLATES

(71) Applicants: Northrop Grumman Systems Corporation, Falls Church, VA (US); The Board of Trustees of the Leland Stanford Junior University, Stanford, CA (US)

(72) Inventors: Edward M. Silverman, Encino, CA (US); John A. Starkovich, Redondo Beach, CA (US); Hsiao-Hu Peng, Rancho Palos Verdes, CA (US); Jesse B. Tice, Torrance, CA (US); Michael T. Barako, Gettysburg, PA (US); Conor E. Coyan, Redwood City, CA (US); Kenneth E. Goodson, Portola Valley, CA (US)

(21) Appl. No.: 15/006,597

(22) Filed: Jan. 26, 2016

Related U.S. Application Data
(60) Provisional application No. 62/121,010, filed on Feb. 26, 2015.

(51) Int. Cl. C25D 5/02; F28F 3/02; B32B 15/01

(52) U.S. Cl. CPC C25D 5/022; B32B 15/01; F28F 3/022

(57) ABSTRACT

A method for making a thermal interface material (TIM) comprises the steps of: depositing a seed layer onto a substrate; attaching a template membrane to the substrate; depositing metal into one or more of the pores of the template membrane, substantially filling the template membrane to create a vertically-aligned metal nanowire (MNW) array comprising a plurality of nanowires that grow upward from the seed layer; and after the template membrane is substantially filled with the deposited metal, removing the template membrane, leaving the plurality of nanowires attached to the seed layer. A TIM comprises: a vertically-aligned MNW array comprising a plurality of nanowires that grow upward from a seed layer deposited on the surface of a template membrane, and the template membrane being removed after MNW growth.

### PRIORITY CLAIM

The present application claims the priority benefit of U.S. provisional patent application No. 62/121,010 filed Feb. 26, 2015 and entitled “Vertically Aligned Metal Nanowire Arrays and Composites for Thermal Management Applications,” the disclosure of which is incorporated herein by reference.

### CROSS-REFERENCE TO RELATED APPLICATION

This application contains subject matter that is related to the subject matter of the following applications, which are assigned to the same assignee as this application. The below-listed U.S. patent application is hereby incorporated herein by reference in its entirety:

“HIGH-CONDUCTIVITY BONDING OF METAL NANOWIRE ARRAYS,” by Barako, Starkovich, Silverman, Tice, Goodson, and Peng, filed on ______, U.S. Ser. No. ______.

### SUMMARY

A method for making a thermal interface material (TIM) includes the steps of: depositing a seed layer onto a substrate; attaching a sacrificial porous template membrane to the substrate; depositing metal into one or more of the pores of the template membrane, substantially filling the template membrane to create a vertically-aligned metal nanowire (MNW) array comprising a plurality of nanowires that grow upward from the seed layer; and after the template membrane is substantially filled with the deposited metal, removing the template membrane, leaving the plurality of nanowires attached to the seed layer.

A method for making a thermal interface material (TIM) includes the steps of: depositing a seed layer onto a sacrificial porous template membrane; thickening the seed layer; depositing metal into one or more of the pores of the template membrane, substantially filling the template membrane to create a vertically-aligned metal nanowire (MNW) array comprising a plurality of nanowires that grow upward from the seed layer; and after the template membrane is substantially filled with the deposited metal, removing the template membrane, leaving the plurality of nanowires attached to the seed layer.

A method for making a thermal interface material (TIM) includes the steps of: depositing a seed layer that functions as a cathode onto a substrate; attaching a sacrificial porous template membrane to the substrate; electrodepositing metal into one or more of the pores of the template membrane, substantially filling the template membrane to create a vertically-aligned metal nanowire (MNW) array comprising a plurality of nanowires that grow upward from the seed layer; electrodepositing additional metal to extend growth from the tips of the nanowires to make the MNW array thicker than the template membrane; and after the template membrane is substantially filled with the electrodeposited metal, removing the template membrane, leaving the plurality of nanowires attached to the seed layer.

A method for making a thermal interface material (TIM) includes the steps of: depositing a seed layer that functions as a cathode onto a sacrificial porous template membrane; thickening the seed layer; electrodepositing metal into one or more of the pores of the template membrane, substantially filling the template membrane to create a vertically-aligned metal nanowire (MNW) array comprising a plurality of nanowires that grow upward from the seed layer; electrodepositing additional metal to extend growth from the tips of the nanowires to make the MNW array thicker than the template membrane; and after the template membrane is substantially filled with the electrodeposited metal, removing the template membrane, leaving the plurality of nanowires attached to the seed layer.

A thermal interface material (TIM) includes: a vertically-aligned metal nanowire (MNW) array comprising a plurality of nanowires that grow upward from a seed layer deposited onto a template membrane, the template membrane being removed after MNW growth.

### DESCRIPTION OF THE DRAWINGS

The accompanying drawings provide visual representations which will be used to more fully describe various representative embodiments and can be used by those skilled in the art to better understand the representative embodiments disclosed herein and their inherent advantages. In these drawings, like reference numerals identify corresponding elements.

FIG. 1 is a drawing showing the general growth procedure for vertically-aligned MNW arrays using a sacrificial template via both freestanding and on-substrate growth, producing thermal interface materials (TIMs).

FIGS. 2A-2F are a set of drawings showing representative configurations of vertically-aligned metal nanowire (MNW) thermal interface materials (TIMs).

FIGS. 3A-3B are a set of photographs showing removal of superfilled template membrane overplating and membrane dissolution for a TIM comprising a one-sided, on-substrate, vertically-aligned metal nanowire array.

FIGS. 4A-4D are a set of scanning electron microscopy (SEM) images of one-sided, vertically-aligned metal nanowire (MNW) arrays grown on a substrate without interstitial filling, producing thermal interface materials (TIMs).

FIGS. 5A-5D are a set of cross-sectional scanning electron microscopy (SEM) images of vertically-aligned metal nanowire (MNW) arrays by template-assisted electrodeposition in representative configurations.

FIGS. 6A-6B are a pair of schematic drawings showing metal nanowire growth extension beyond the membrane thickness limit.

FIG. 7 is a flowchart of a method for making a thermal interface material (TIM) on a substrate.

FIG. 8 is a flowchart of a method for making a freestanding thermal interface material (TIM).

FIG. 9 is a flowchart of a method for making a thermal interface material (TIM) exhibiting extended growth on a substrate.

FIG. 10 is a flowchart of a method for making a freestanding thermal interface material (TIM) exhibiting extended growth.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

According to embodiments of the invention, vertically-aligned metal nanowire (MNW) arrays are provided for thermal management applications. According to further embodiments of the invention, the MNW arrays have one or more of high effective thermal conductivity and mechanical compliance. For example, the thermal conductivity is at least approximately 40 Watts per (meter-Kelvin) or 40 W/(m-K). For example, the thermal conductivity is less than or equal to approximately 200 W/(m-K). According to other embodiments of the invention, the MNW array is filled with a phase change material (PCM) to provide one or more of latent heat capacity and sensible heat capacity. The PCM can also buffer transient thermal loads. The MNW-PCM composite can also enhance the effective thermal conductivity compared to the traditional PCM material. According to further embodiments of the invention, the MNW arrays are modified with growth beyond the thickness of a single template membrane to provide compliant, semi-oriented surface structures. The modified growth procedure can increase the MNWs' lateral interconnectivity, that is, the thermal conductivity between individual MNWs across the lateral dimensions of the array.

According to other embodiments of the invention, vertically-aligned arrays of metal nanowires are provided that are optimized and applied as mechanically-compliant, thermally-conductive thermal interface materials (TIMs).

According to other embodiments of the invention, vertically-aligned arrays of metal nanowires are provided that are optimized and applied as mechanically-compliant, thermally-conductive thermal interface materials (TIMs).

According to further embodiments of the invention, the MNW arrays are synthesized using porous template membranes as sacrificial templates and employing electrochemically deposited metal within the template membrane. According to yet other embodiments of the invention, the template membrane may be subfilled, which generates a one-sided array. Alternatively, or additionally, according to further embodiments of the invention, the template membrane may be superfilled, which generates a two-sided array. According to yet other embodiments of the invention, the porous template membrane masks the conductive surface of the substrate. According to still further embodiments of the invention, the MNWs are then deposited into one or more of the pores. For example, upon completing the nanowire (NW) deposition, the template membrane may be chemically dissolved, leaving an open access MNW array.

According to other embodiments of the invention, the uniformity of the one-sided MNW array depends on the uniformity of the metal deposition conditions. According to still further embodiments of the invention, to achieve a more highly uniform MNW array, a superfilled, two-sided MNW array can be converted to a one-sided MNW array. According to yet other embodiments of the invention, the conversion to a one-sided MNW array may be accomplished after deposition of the nanowires and prior to removing the template membrane by mechanically peeling off the solid overplated film that deposits above the pores once the pores are already filled. According to this set of embodiments of the invention, the template membrane serves as a protective medium to preserve the morphology of the MNWs during overplating removal.

According to further embodiments of the invention, the MNWs achieve low total thermal resistance and foster heat transfer across the interface, thereby reducing hot-side junction temperature. According to still further embodiments of the invention, the MNWs achieve one or more of long-lifetime operation and reliable TIM operation. For example, according to other embodiments of the invention, the MNWs are applied as TIM's that provide a reduction in operating temperatures of microelectronic devices of between approximately 5 degrees centigrade and approximately 10 degrees centigrade. For example, the MNWs are applied as TIM's that provide an improvement of between approximately 1.25 times and approximate 2 times in the mean time between failures (MTBF) for one or more of a CMOS device and a bipolar logic-based device. Accordingly, one or more of next generation circuits and next generation devices can be designed for high capability operation if operated at the same temperature as the operating temperature for the prior art devices. For example, high capability operation comprises one or more of a higher circuit density and a higher power density.

According to still further embodiments of the invention, the MNWs alleviate thermomechanical stresses. According to other embodiments of the invention, the MNWs mitigate one or more of cracking, delamination, and other modes of TIM failure. According to yet further embodiments of the invention, the alignment of the MNWs minimizes the effective length of the heat transfer pathway across the interface, thereby reducing the TIM thermal resistance. According to yet other embodiments of the invention, the MNWs have a high aspect ratio. Aspect ratio is defined as the ratio of a length of the MNW to a diameter of the MNW. For example, the MNWs have an aspect ratio of at least approximately 20. For example, the MNWs have an aspect ratio less than or equal to approximately 10,000.

For example, the individual MNWs can bend. For example, the individual MNWs can conform to one or more of non-parallel surfaces and rough surfaces. For example, the individual MNWs thereby permit higher contact areas. Therefore, the individual MNWs thereby provide lower contact resistances and can be bonded to an adjacent surface to further reduce contact resistance. For example, the contact resistance is at least approximately 1 square millimeter-Kelvin per Watt or 1 (mm²-K)/W. For example, the contact resistance is less than or equal to approximately 10 (mm²-K)/W. According to still further embodiments of the invention, following the growth of the MNWs, the interstitial space between MNWs can be infiltrated with a material so as to accomplish one or more of providing additional functionality to the TIM, further tuning one or more of the composite's thermal properties and the composite's mechanical properties, and positioning the material inside the MNW structure and away from the top surface of the MNW tips, where heat exchange occurs.

If desired, the free array may optionally be treated to a short post-growth plating period to deposit a small amount of metal within the array. According to certain embodiments of the invention, this step introduces a lateral connectivity to improve lateral thermal conductivity of the structure. According to yet other embodiments of the invention, the amount of the lateral interconnect deposit introduced must be controlled in order to preserve the compliant brush-like structure of the MNW array.

According to further embodiments of the invention, other post-growth treatments may be employed to add functionality to the MNW array. For example, according to additional embodiments of the invention, the copper MNW TIM's can have a protective anti-oxidation coating applied to maintain their long term operational functionality. For example, the anti-oxidation coating can be an anti-oxidation film. For example, the anti-oxidation coating may be applied for elevated temperature applications of approximately 150° C. or more. For example, the anti-oxidation coating comprises one or more of nickel, cobalt, platinum, rhodium, palladium, iridium, and another noble metal. For example, the anti-oxidation coating may be applied to the MNW array by one or more of electrochemical and electroless deposition methods after the MNW array has been grown and removed from the template membranes. For example, the anti-oxidation coating may be applied to the MNW array by one or more of atomic layer deposition and chemical vapor deposition.

For example, the deposition may comprise one or more of electrodeposition, potentiostatic deposition of the MNW, galvanostatic deposition, and electroless deposition methods. Electrodeposition may comprise one or more of direct current electrodeposition, pulsed electrodeposition, potentiostatic deposition, galvanostatic deposition, and other electrochemical deposition methods. Electroless deposition methods may comprise a chemical method using one or more reducing agents. For example, the reducing agent comprises one or more of citrate, formaldehyde, hydrazine, sodium borohydride, lithium aluminum hydride, aminoborane, and another reducing agent.

For example, the anti-oxidation coating deposition may comprise pulsed electrodeposition of nickel. For example, the deposition may comprise atomic layer deposition. For example, the deposition may comprise atomic layer deposition of conformal aluminum oxide (Al₂O₃).

The interstitial volume of the vertically-aligned MNW array may further comprise a polymeric matrix configured to provide one or more of mechanical stability and handleability. For example, the interstitial volume of the vertically-aligned MNW array may further comprise a PCM configured to provide the TIM with one or more of latent heat capacity and sensible heat capacity. For example, the one or more of latent heat capacity and sensible heat capacity may buffer transient thermal loads that may arise under power surge conditions. The PCM may comprise one or more components that do not react with and do not alloy with the MNWs. For example, the PCM may comprise one or more of high molecular weight paraffins having a molecular weight of C21-C60, thermoplastic polymers, silicones, inorganic salts, low melting point alloys, and eutectics. For example, the PCM may comprise a eutectic metal alloy. For example, the PCM may comprise a eutectic gold/tin (AuSn) metal alloy. A eutectic-infiltrated MNW array may be used to bond Gallium Nitride (GaN) chips to a substrate while achieving low thermal interface resistance and mechanical compliance.

According to embodiments of the invention, infiltration of the PCM into the MNW structure without affecting the array morphology uses vacuum-assisted infusion of low viscosity PCM solutions. For example, the solvent must possess a suitable solubility for the PCM. For example, the solvent wets the MNWs. For example, the solvent has a relatively high freezing point. For example, the relatively high freezing point allows the solvent to be conveniently frozen and removed via sublimation. For example, alternatively or additionally, the relatively high freezing point allows the solvent to be exchanged with an exchange solvent and dried above the critical point. For example, the exchange solvent is liquid carbon dioxide. According to other embodiments of the invention, subsequent to the infiltration of the PCM into the MNW structure, the carrier solvent is removed. The removal of the solvent is performed so as to avoid stresses from one or more of drying and evaporative loss. For example, the removal of the solvent is performed so as to preserve one or more of the orientation and the structure of the nanowire array.

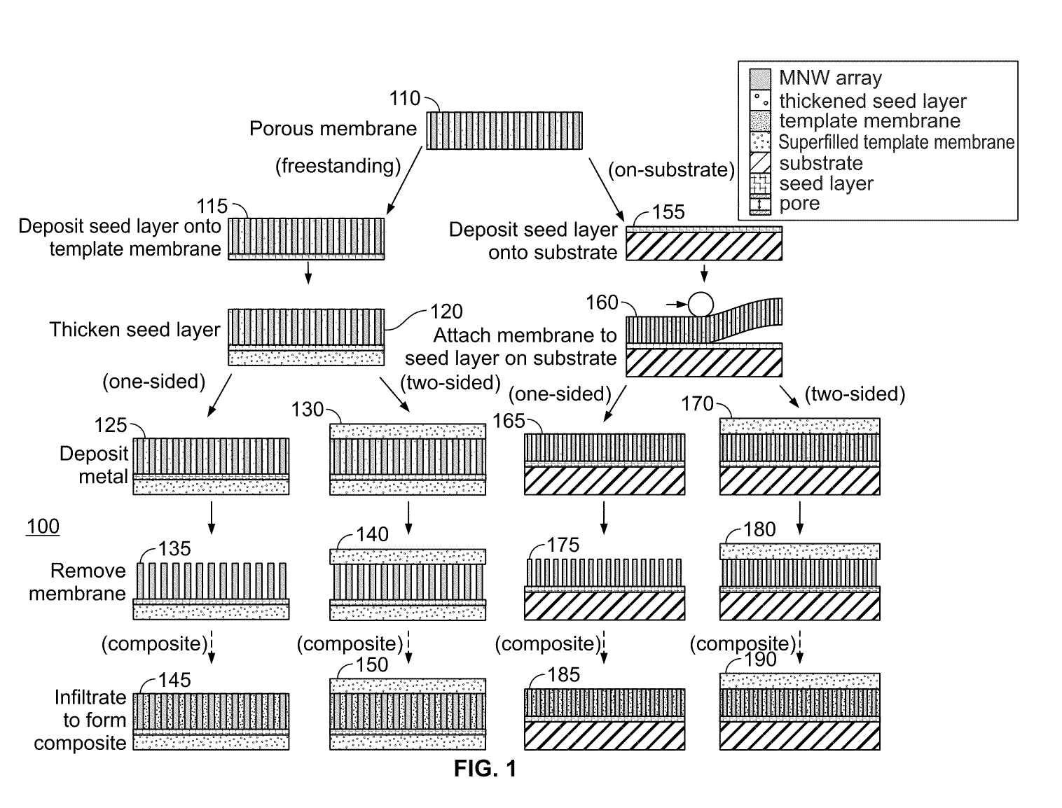

FIG. 1 is a drawing showing the general growth procedure 100 for template-grown, vertically-aligned MNW arrays using both free-standing and on-substrate growth methods. The legend indicates the various components. The MNW arrays are synthesized using porous membranes as sacrificial templates and employing electrochemically deposited metal within the template membrane. The template membrane may be subfilled, which generates a one-sided array. The template membrane may be superfilled, which generates a two-sided array. The porous template membrane masks the conductive surface of the substrate. The MNWs are then deposited into one or more of the pores. For example, upon completing the nanowire (NW) deposition, the template membrane may be chemically dissolved, leaving an open access MNW array.

The uniformity of the one-sided MNW array depends on the uniformity of the metal deposition conditions. To achieve a more highly uniform MNW array, a superfilled, two-sided MNW array can be converted to a one-sided MNW array. The conversion to a one-sided MNW array may be accomplished after deposition of the nanowires and prior to removing the template membrane by mechanically peeling off the solid overplated film that deposits above the pores once the pores are already filled. In this case, the template membrane serves as a protective medium to preserve the morphology of the MNWs during overplating removal.

In step 110, a sacrificial porous template membrane is prepared so that the pore diameter corresponds to the desired nanowire diameter. The sacrificial porous template membrane is also prepared so that the pore density corresponds to the desired nanowire number density.

Steps 115 through 150 apply to freestanding MNW array growth techniques, in which a substrate is not used. In step 115, a seed layer is deposited onto the template membrane. For example, the seed layer is deposited on the surface of the template membrane. A vat is prepared by filling the vat with a growing medium. The vat comprises one or more of an electrochemical vat and an electroless vat. The growing medium comprises one or more of a plating solution, an electroless solution, and an ionic liquid. The template membrane is placed in the vat. In step 120, the seed layer, which will later serve as the platform upon which the nanowires are attached, is thickened. For example, the seed layer is electrochemically thickened. For example, the seed layer is thickened by attaching one or more of foil and a polymer to its back. For example, the seed layer is thickened using a thin film deposition technique. In step 125, in the case of a one-sided freestanding MNW array, metal is then deposited into either a subfilled template membrane or a superfilled template membrane with the overplating removed, to create an MNW array. In step 130, in the case of a two-sided freestanding MNW array, metal is then deposited into a superfilled template membrane to create a MNW array. In step 135, in the case of a one-sided, freestanding MNW, the template membrane is removed. For example, the step of removing the template membrane can be performed by etching the template membrane with plasma, so as to gasify the template membrane. For example, the step of removing can be performed by carefully using a solvent to perform one or more of partial dissolution and complete dissolution of the template membrane.

In step 140, in the case of a two-sided, freestanding MNW array, the template membrane is removed. Again, for example, the step of removing the template membrane can be performed by etching the template membrane with plasma, so as to gasify the template membrane. For example, the step of removing can be performed by carefully using a solvent to perform one or more of partial dissolution and complete dissolution of the template membrane.

In step 145, in the case of a one-sided, freestanding MNW array, a matrix material is optionally infiltrated into the free space to form a composite. In step 150, in the case of a two-sided, freestanding MNW array, a matrix material is optionally infiltrated into the free space to form a composite.

Steps 155 through 190 apply to on-substrate growth techniques, in which a substrate is used. In step 155, an initial seed layer is deposited on the substrate. For example, the substrate comprises one or more of glass, silicon, and metal

In step 160, a template membrane is attached to the substrate. A vat is again prepared by filling the vat with a growing medium. The vat comprises one or more of an electrochemical vat and an electroless vat. The growing medium comprises one or more of a plating solution, an electroless solution, and an ionic liquid.

The substrate with attached template membrane is again placed in the vat. In step 165, in the case of a one-sided on-substrate MNW, metal is then deposited into either a subfilled template membrane or a superfilled template membrane overplating that is subsequently removed, to create an MNW array. In step 170, in the case of a two-sided, on-substrate MNW array, metal is then deposited onto a superfilled template membrane to create an MNW array. In step 175, in the case of a one-sided, on-substrate MNW array, the template membrane is removed. Again, for example, the step of removing the template membrane can be performed by etching the template membrane with plasma, so as to gasify the template membrane. For example, the step of removing can be performed by carefully using a solvent to perform one or more of partial dissolution and complete dissolution of the template membrane.

In step 180, in the case of a two-sided, on-substrate MNW array, the template membrane is removed. Again, for example, the step of removing the template membrane can be performed by etching the template membrane with plasma, so as to gasify the template membrane. For example, the step of removing can be performed by carefully using a solvent to perform one or more of partial dissolution and complete dissolution of the template membrane.

In step 185, in the case of a one-sided, on-substrate MNW array, a matrix material is optionally infiltrated into the free space to form a composite. In step 190, in the case of a two-sided, on-substrate MNW array, a matrix material is optionally infiltrated into the free space to form a composite.

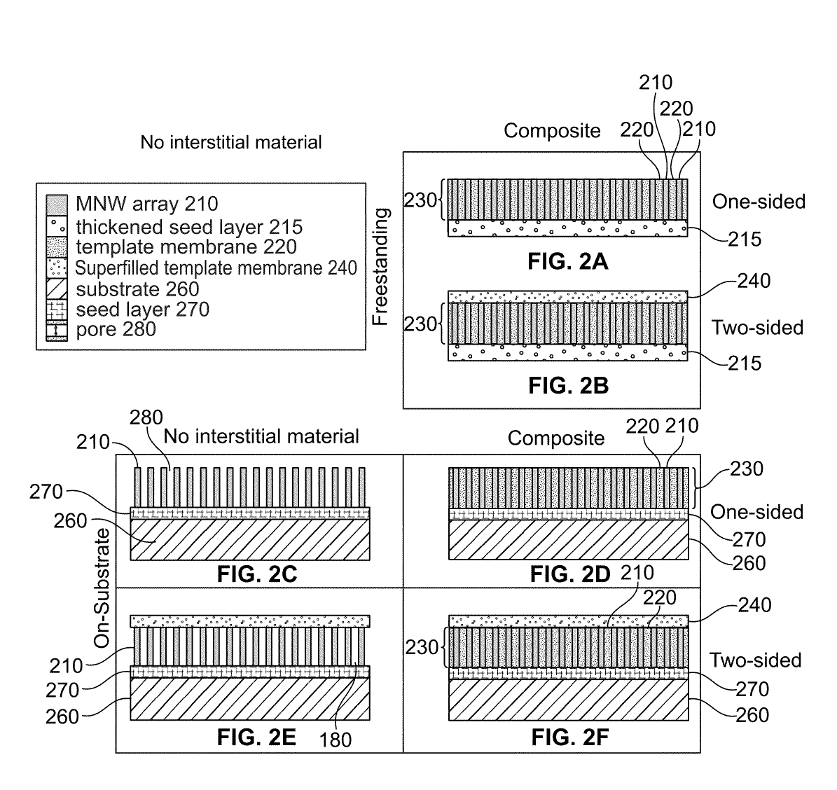

FIGS. 2A-2F are a set of drawings showing representative configurations of vertically-aligned metal nanowire (MNW) thermal interface materials (TIMs). The legend again indicates the various components. FIGS. 2A-2B show growth onto a cathode attached directly to the membrane. FIGS. 2C-2F show growth directly onto a substrate of vertically-aligned MNW TIMs. According to embodiments of the invention, the freestanding TIMs are grown and infiltrated using inventive methods of polymeric infiltration as in FIGS. 2A-2B. The TIMs grown directly onto a substrate as in FIGS. 2C-2F only require bonding on one interface, which allows the MNWs to be brought into intimate contact with one or more of the heat-generating device surface and the heat sink surface with no additional bond line.

According to other embodiments of the invention, one or more of the one-sided and two-sided configurations can be infiltrated with an interstitial material to form a composite. For example, the interstitial material may comprise one or more of thermally-passive materials and thermally-active materials. For example, the thermally-passive materials may comprise mechanical stabilizers. For example, the mechanical stabilizers may comprise one or more of polydimethylsiloxane (PDMS) and epoxy. For example, the thermally-active materials may comprise PCM's that may provide added thermal capacitance. For example, the PCM's may comprise paraffin wax.

FIG. 2A depicts a set of embodiments in which a one-sided, composite free-standing MNW array is grown using either a subfilled template membrane or a superfilled template membrane with the overplating removed. After the MNW array 210 is grown on a thickened seed layer 215, it is infiltrated with a composite 220 using polymeric infiltration to create a composite MNW array 230. FIG. 2B depicts a set of embodiments in which a two-sided, composite free-standing MNW array is grown using a superfilled template membrane 240. After the MNW array 210 is grown on a thickened seed layer 215, it is infiltrated with the composite 220 using polymeric infiltration to create a composite MNW array 230. FIG. 2C depicts a set of embodiments in which a one-sided MNW array 210 with no interstitial material is grown directly onto a substrate 260 using a seed layer 270 and one or more of a superfilled template membrane overplating that is subsequently removed and a subfilled template membrane comprising pores 280. FIG. 2D depicts a set of embodiments in which a one-sided, composite MNW array 210 is grown directly onto the substrate 260 using the seed layer 270 with one or more of a superfilled template membrane overplating that is subsequently removed and a subfilled template membrane. The MNW array is infiltrated with the composite 220 using polymeric infiltration to create the composite MNW array 230. FIG. 2E depicts a set of embodiments in which a two-sided MNW array 210 with no interstitial material is grown directly onto a substrate 260 using the seed layer 270 and the superfilled template membrane 240. FIG. 2F depicts a set of embodiments in which a two-sided, composite MNW array 210 is grown directly onto the substrate 260 using the seed layer 270 and the superfilled template membrane 240 and infiltrated with the composite 220 using polymeric infiltration to create the composite MNW array 230.

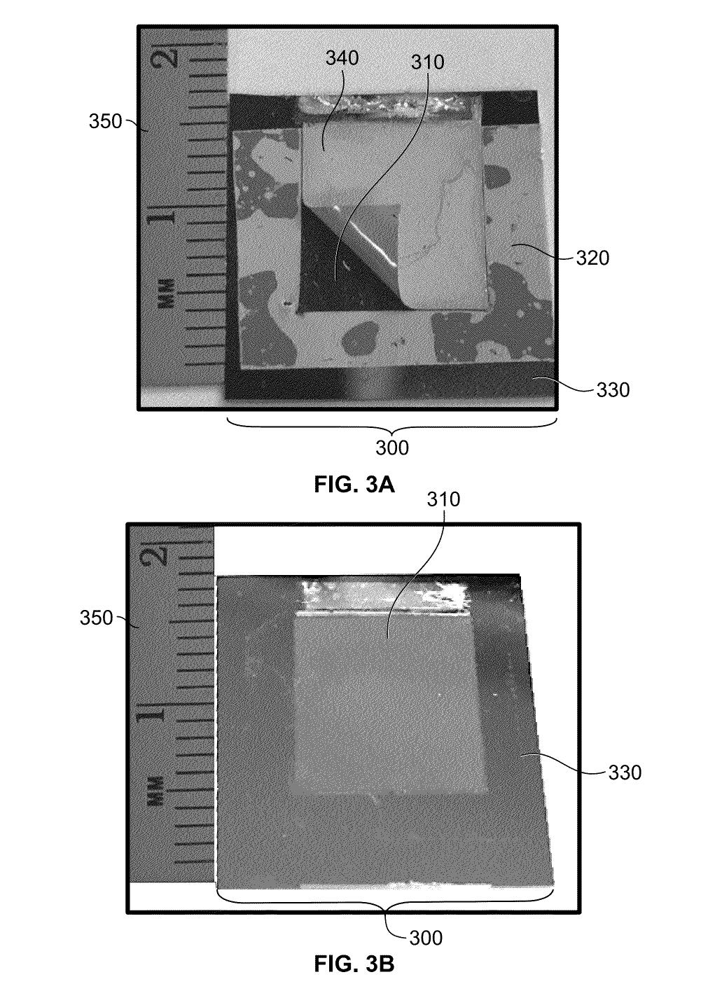

FIGS. 3A-3B are a set of photographs showing removal of superfilled template membrane overplating and membrane dissolution for a thermal interface material (TIM) comprising a one-sided, on-substrate, vertically-aligned metal nanowire array. In FIG. 3A, a one-sided, on-substrate embodiment of the thermal interface material 300 is shown using a metal nanowire (MNW) array 310 and a sacrificial template membrane 320 on a silicon substrate 330. FIG. 3A also depicts an ability to peel off overplating 340 in a single piece 340. The size regime is graphically illustrated by a millimeter ruler 350.

In FIG. 3B, the one-sided, on-substrate thermal interface material 300 is shown comprising the MNW array 310 on the silicon substrate 330 after dissolution of the template membrane 320. In FIG. 3B, the millimeter ruler 350 demonstrates the high degree of uniformity of the array 310 that can be achieved on a scale of centimeters.

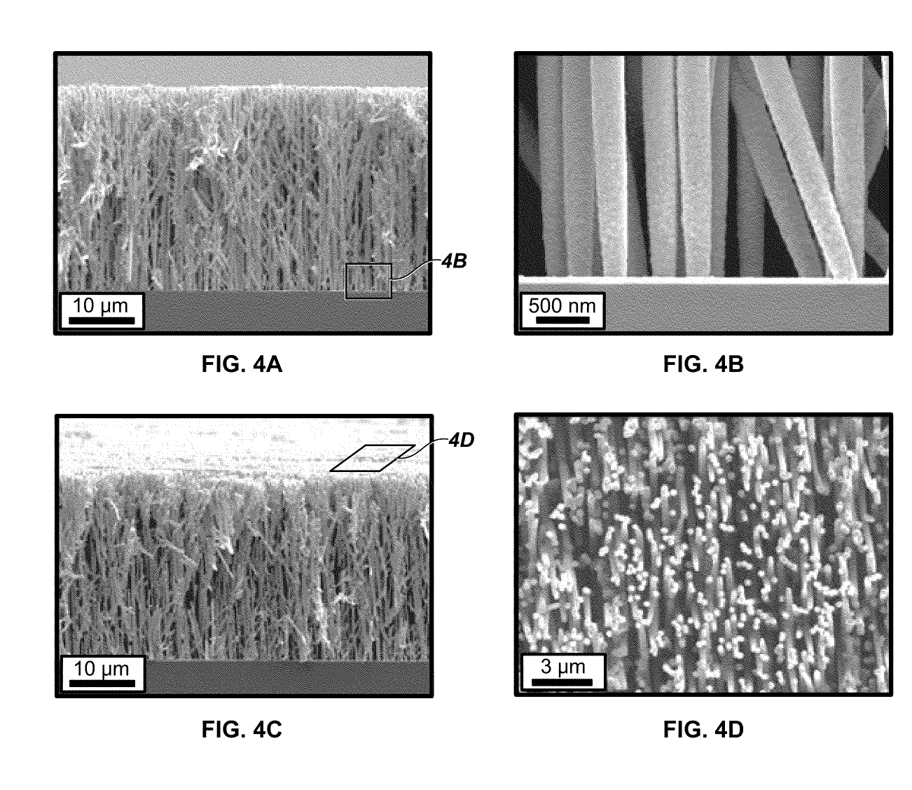

FIGS. 4A-4D are a set of scanning electron microscopy (SEM) images of one-sided, vertically-aligned MNW arrays grown on a substrate without interstitial filling, producing thermal interface materials (TIMs). As long as the over-plated film is substantially continuous, it can be removed as a single piece that cleaves at the interface with the tips of the MNWs. For example, substantial continuity may be defined as thickness greater than approximately five micrometers (μm). After metal deposition and growth on the substrate of the one-sided MNW arrays, the sacrificial template membrane is removed as shown in FIGS. 4A-4D. Upon removal of the template membrane, a one-sided MNW array is obtained of substantially uniform thickness. Alternatively, the resulting MNW arrays can then be infiltrated with an interstitial matrix material to form a composite.

FIG. 4A depicts a cross-sectional SEM image. The scale is such that 0.5 inches in the figure roughly corresponds to 10 μm in the array. Such arrays are nominally vertically-aligned and can be synthesized to be highly uniform over areas on the scale of square centimeters.

FIG. 4B depicts a cross-sectional SEM image of the interface between an MNW and a substrate. The scale is such that 0.5 inches in the figure roughly corresponds to 500 nanometers (nm) in the array. Through electrostatic template adhesion, nanowires are grown directly from the metallized substrate with no intermediate binding layer and with no transition region.

FIG. 4C depicts a cross-sectional small angle SEM image of an array. The scale is such that 0.5 inches in the figure roughly corresponds to 10 μm in the array. The array achieves a high degree of planarity over its surface.

FIG. 4D depicts a plan view SEM image of MNW tips. The scale is such that 0.5 inches in the figure roughly corresponds to 3 μm in the array. This top view of the MNW array shows both the alignment of the nanowires and the relative density of the array.

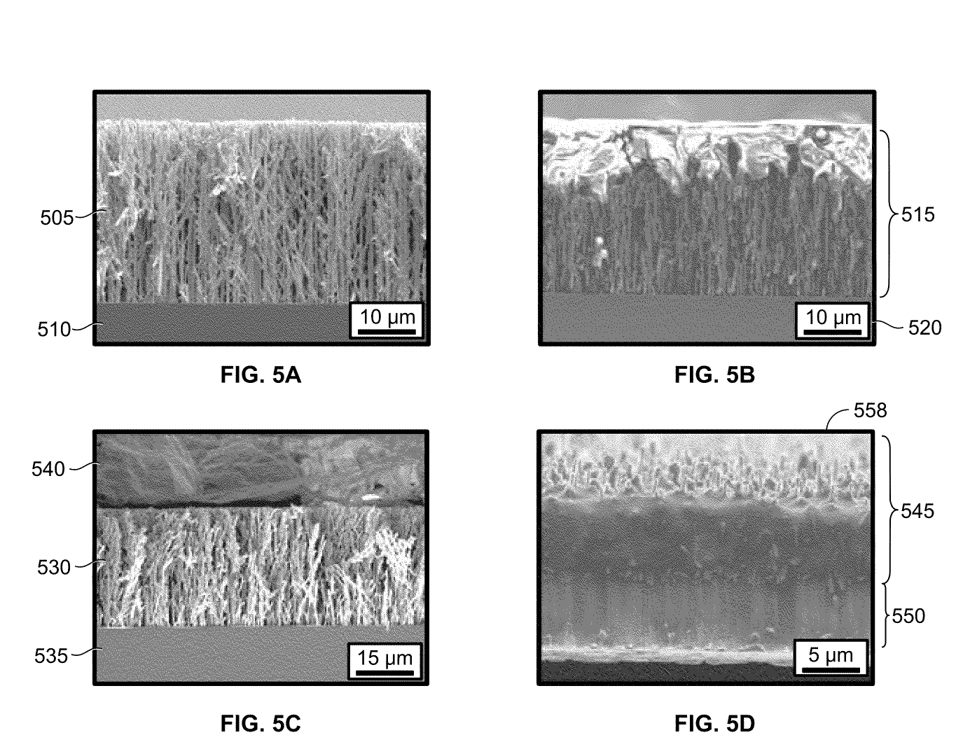

FIGS. 5A-5D are a set of cross-sectional scanning electron microscopy (SEM) images of vertically-aligned MNW arrays grown by template-assisted electrodeposition in representative configurations. FIGS. 5A-5C are images of on-substrate examples while FIG. 5D is an image of a freestanding example.

FIG. 5A depicts a non-infiltrated, one-sided, on-substrate copper MNW array 505 synthesized on a silicon substrate 510.

FIG. 5B depicts a one-sided, on-substrate copper MNW array 515 synthesized on a silicon substrate 520 and infiltrated with a polymer matrix 515. The array 515 and the matrix 515 form a single contiguous volume 515.

FIG. 5C depicts a non-infiltrated, two-sided, on-substrate copper MNW array 530 synthesized on a silicon substrate 535 with a superfilled template membrane overplating layer 540 on the top surface.

FIG. 5D depicts a freestanding, one-sided copper MNW array 545 synthesized as a freestanding film 545 grown on an electrochemically thickened seed layer 550 and infiltrated with a polymer matrix 545, showing exposed MNW tips 558 that are sticking out beyond the polymer matrix 545. The MNWs are attached to the electrochemically thickened seed layer 550. The array 545 and the matrix 545 form a single contiguous volume 545.

According to other embodiments of the invention, a method is provided for producing nanowire arrays comprising extended electrodeposition beyond the thickness of a single template membrane. According to these embodiments of the invention, metal is deposited until the template membrane is entirely filled, after which an alternative, non-templated deposition technique is used to continue the growth from the tips of the nanowires beyond the height of the template membrane.

According to other embodiments of the invention, a method is provided for producing nanowire arrays comprising the use of multiple stacked growth template membranes in one-sided embodiments and in two-sided embodiments after removal of the superfilled template membrane overplating. Two or more template membranes are stacked. The pores in the stacked template membranes are substantially aligned in order to grow the MNW using the stacked membranes as templates. While the extended growth portion of the MNW array may be less vertically-aligned than the portion grown within the template membrane, the extended growth portion is highly conductive. Moreover, the extended growth portion serves as a useful contacting surface for a TIM. The morphology of the extended growth regime may exhibit one or more of a more tangled structure and a mat-like structure. For example, such structures can aid formation of a TIM that is one or more of self-standing and mechanically stable. For example, such a TIM can be handled without requiring an infusion of one or more of a stabilizing polymer and another matrix.

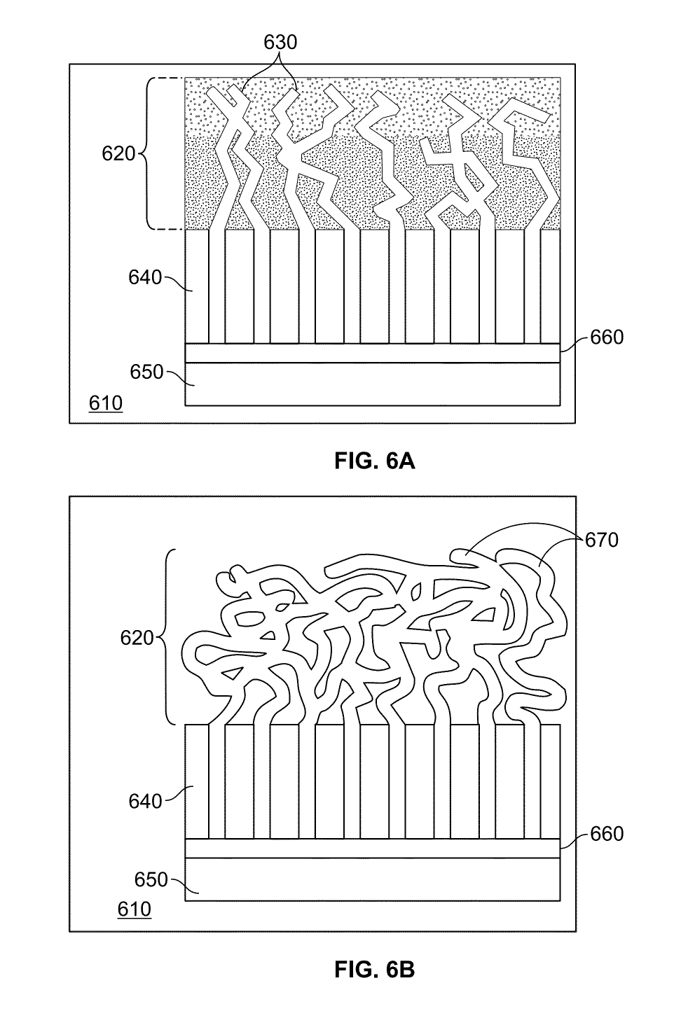

FIGS. 6A-6B are a pair of schematic drawings showing metal nanowire growth extension beyond the membrane thickness limit. The MNW arrays can be modified under an extended growth procedure that enables substantial MNW growth beyond the membrane thickness in an electrochemical bath. For example, the extended MNW growth morphology may be less perfectly aligned than the MNWs within the membrane pores. Nevertheless, according to embodiments of the invention, the extended growth procedure provides a surface structure that is one or more of compliant, semi-oriented, and mat-like. The details of the surface structure are dependent on the particular growth conditions employed.

As shown in FIG. 6A, if a vat 610 comprises a plating solution 610 that is co-extensive with the vat and that in turn comprises a gel electrolyte 620, and if direct current (DC) potentiostatic control is employed, a somewhat less vertically-aligned array 630 may be produced. The electrolyte 620 provides electrical conductivity for the plating and deposition process in the plating solution 610 that surrounds the structure. For example, the electrolyte 620 comprises a simple liquid ionized salt solution with dissolved ions. For example, the electrolyte 620 comprises a gel electrolyte 620 having the consistency of a gel and a yield stress. In such cases, one or more of bulk movement and convective flow are reduced, providing a quiescent medium in which ions can diffuse throughout the growing array.

Under such circumstances, quiescent, undisturbed, extended growth of relatively straight MNW 630 will be favored on a template membrane 640 using a thickened seed layer 650 grown from a seed layer 660. If no bulk movement of the plating solution occurs, and no convection motion occurs in the plating solution 610, MNW tip growth extension and length extension may be favored, producing a vertically-aligned array 630 similar to that illustrated in FIG. 6A.

As shown in FIG. 6B, if the vat 610 comprises a plating solution 610 that again is co-extensive with the vat and that is stirred, or if no gel electrolyte 620 is used, perturbed growth occurs and a more tangled or mat-like, non-quiescent, extended MNW structure 670 will be produced. Under such circumstances, the non-quiescent, disturbed, extended MNW growth 670 will be favored on the template membrane 640 using the thickened seed layer 650 grown from the seed layer 660. According to this set of embodiments of the invention, multiple membranes 640 may be stacked vertically on top of each other. According to this set of embodiments of the invention, electrodeposition may continue until the nanowire growth 670 emerges from the top membrane 640. For extended MNW growth using multiple stacked membranes, the pores of the membranes 640 in the stack may not align perfectly, thereby causing a small kink or nodule to arise in the direction of nanowire growth.

Such nodules will probably not substantially affect the thermal conductivity of the MNW array. Such nodules may be annealed in a post-growth procedure to reduce stresses. In a refinement of the growth technique, MNWs comprising one or more of copper and silver may be grown in a manner in which the core MNW is coated by a shell comprising one or more of nickel and a more noble metal, for example, gold. This core-shell structure is advantageous since it permits one or more of copper-based MNW arrays and silver-based MNW arrays to be used for heat transfer applications involving high temperature oxidizing environments.

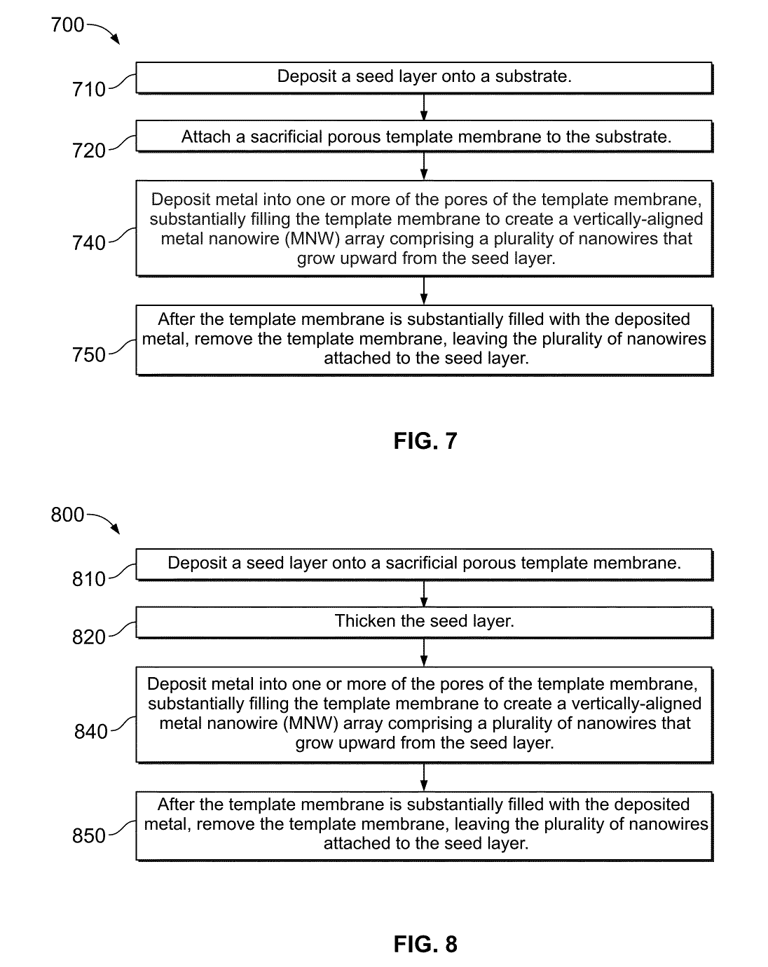

FIG. 7 is a flowchart of a method 700 for making a thermal interface material (TIM) in an on-substrate embodiment. The order of the steps in the method 700 is not constrained to that shown in FIG. 7 or described in the following discussion. Several of the steps could occur in a different order without affecting the final result.

In step 710, a seed layer is deposited onto a substrate. Block 710 then transfers control to block 720.

In step 720, a sacrificial porous template membrane is attached to the substrate. The template membrane comprises one or more of a ceramic membrane and a polymer membrane. A vat is prepared by substantially filling the vat with a growing medium. The vat comprises one or more of an electrochemical vat and an electroless vat. The growing medium comprises one or more of a plating solution, an electroless solution, and an ionic liquid. The template membrane is placed in the vat. Block 720 then transfers control to block 740.

In step 740, metal is deposited into one or more of the pores of the template membrane, substantially filling the template membrane to create a vertically-aligned metal nanowire (MNW) array comprising a plurality of nanowires that grow upward from the seed layer. Block 740 then transfers control to block 750.

In step 750, after the template membrane is substantially filled with the deposited metal, the template membrane is removed, leaving the plurality of nanowires attached to the seed layer. For example, the step of removing can be performed by etching the template membrane with plasma, so as to gasify the template membrane. For example, the step of removing can be performed by carefully using a solvent to perform partial dissolution of the template membrane.

What remains then is the nanowires attached to the seed layer. The nanowires are brushlike and may be fairly fragile. Block 750 then terminates the process.

FIG. 8 is a flowchart of a method 800 for making a freestanding thermal interface material (TIM). The order of the steps in the method 800 is not constrained to that shown in FIG. 8 or described in the following discussion. Several of the steps could occur in a different order without affecting the final result.

In step 810, a seed layer is deposited onto a sacrificial porous template membrane. For example, the seed layer is deposited on the surface of the template membrane. The template membrane comprises one or more of a ceramic membrane and a polymer membrane. Block 810 then transfers control to block 820.

In step 820, the seed layer is thickened. For example, the seed layer is electrochemically thickened. For example, the seed layer is thickened by attaching one or more of foil and a polymer to its back. For example, the seed layer is thickened using a thin film deposition technique. A vat is prepared by substantially filling the vat with a growing medium. The vat comprises one or more of an electrochemical vat and an electroless vat. The growing medium comprises one or more of a plating solution, an electroless solution, and an ionic liquid. The template membrane is placed in the vat. Block 820 then transfers control to block 840.

In step 840, metal is deposited into one or more of the pores of the template membrane, substantially filling the template membrane to create a vertically-aligned metal nanowire (MNW) array comprising a plurality of nanowires that grow upward from the seed layer. Block 840 then transfers control to block 850.

In step 850, after the template membrane is substantially filled with the deposited metal, the template membrane is removed, leaving the plurality of nanowires attached to the seed layer. For example, the step of removing can be performed by etching the template membrane with plasma, so as to gasify the template membrane. For example, the step of removing can be performed by carefully using a solvent to perform partial dissolution of the template membrane.

What remains then is the nanowires attached to the seed layer. The nanowires are brushlike and may be fairly fragile. Block 850 then terminates the process.

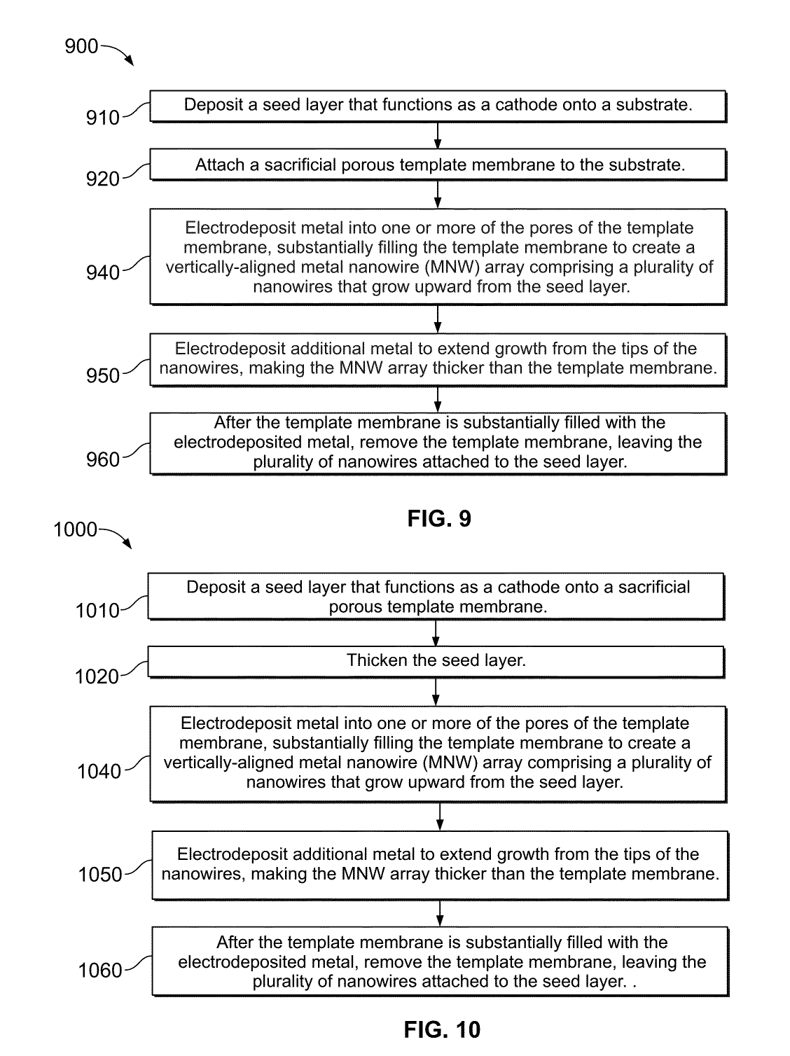

FIG. 9 is a flowchart of a method 900 for making a thermal interface material (TIM) exhibiting extended growth on a substrate. The order of the steps in the method 900 is not constrained to that shown in FIG. 9 or described in the following discussion. Several of the steps could occur in a different order without affecting the final result.

In step 910, a seed layer that functions as a cathode is deposited onto a substrate. The template membrane comprises one or more of a ceramic template membrane and a polymer template membrane Block 910 then transfers control to block 920.

In block 920, a sacrificial porous template membrane is attached to the substrate. The template membrane comprises one or more of a ceramic membrane and a polymer membrane. An electrochemical vat is prepared by substantially filling the vat with a plating solution. The template membrane is placed in the electrochemical vat. Block 920 then transfers control to block 940.

In step 940, metal is electrodeposited into one or more of the pores of the template membrane, substantially filling the template membrane to create a vertically-aligned metal nanowire (MNW) array comprising a plurality of nanowires that grow upward from the seed layer. Block 940 then transfers control to block 950.

In step 950, additional metal is electrodeposited to extend growth from the tips of the nanowires, making the MNW array thicker than the template membrane. Block 950 then transfers control to block 960.

In step 960, after the template membrane is substantially filled with the electrodeposited metal, the template membrane is removed, leaving the plurality of nanowires attached to the seed layer. For example, the step of removing can be performed by etching the template membrane with plasma, so as to gasify the template membrane. For example, the step of removing can be performed by carefully using a solvent to perform one or more of partial dissolution and complete dissolution of the template membrane.

What remains then is the nanowires attached to the seed layer. The nanowires are brushlike and may be fairly fragile. Block 960 then terminates the process.

FIG. 10 is a flowchart of a method 1000 for making a freestanding thermal interface material (TIM) exhibiting extended growth. The order of the steps in the method 1000 is not constrained to that shown in FIG. 10 or described in the following discussion. Several of the steps could occur in a different order without affecting the final result.

In step 1010, a seed layer that functions as a cathode is deposited onto a sacrificial porous template membrane. For example, the seed layer is deposited on the surface of the template membrane. The template membrane comprises one or more of a ceramic template membrane and a polymer template membrane Block 1010 then transfers control to block 1015.

In step 1015, the seed layer is thickened. For example, the seed layer is electrochemically thickened. For example, the seed layer is thickened by attaching one or more of foil and a polymer to its back. For example, the seed layer is thickened using a thin film deposition technique. An electrochemical vat is prepared by substantially filling the vat with a plating solution. The template membrane is placed in the electrochemical vat. Block 1020 then transfers control to block 1040.

In step 1040, metal is electrodeposited into one or more of the pores of the template membrane, substantially filling the template membrane to create a vertically-aligned metal nanowire (MNW) array comprising a plurality of nanowires that grow upward from the seed layer. Block 1040 then transfers control to block 1050.

In step 1050, additional metal is electrodeposited to extend growth from the tips of the nanowires, making the MNW array thicker than the template membrane. Block 1050 then transfers control to block 1060.

In step 1060, after the template membrane is substantially filled with the electrodeposited metal, the template membrane is removed, leaving the plurality of nanowires attached to the seed layer. For example, the step of removing can be performed by etching the template membrane with plasma, so as to gasify the template membrane. For example, the step of removing can be performed by carefully using a solvent to perform one or more of partial dissolution and complete dissolution of the template membrane.

What remains then is again the nanowires attached to the seed layer. The nanowires are again brushlike and may again be fairly fragile. Block 1060 then terminates the process.

Advantages of the invention include the fact that the MNW's may achieve one or more of long-lifetime operation and reliable TIM operation. Also filling the MNW array with a phase change material (PCM) may provide one or more of latent heat capacity and sensible heat capacity. The PCM can also buffer transient thermal loads. The MNW-PCM composite can also enhance the effective thermal conductivity compared to the traditional PCM material.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the time horizon can be adapted in numerous ways while remaining within the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. A method for making a thermal interface material (TIM), comprising the steps of:
depositing a seed layer onto a substrate;
attaching a sacrificial porous template membrane to the substrate;
depositing metal into one or more of the pores of the template membrane, substantially filling the template membrane to create a vertically-aligned metal nanowire (MNW) array comprising a plurality of nanowires that grow upward from the seed layer; and
after the template membrane is substantially filled with the deposited metal, removing the template membrane, leaving the plurality of nanowires attached to the seed layer.

2. The method of claim 1, wherein the template membrane is subfilled, generating a one-sided array.

3. The method of claim 1, wherein the template membrane is superfilled, generating a two-sided array.

4. The method of claim 3, further comprising an additional step, performed after the metal depositing step and prior to the removing step, of:
mechanically peeling off a substantially continuous overplated film deposited above the pores in the depositing step, thereby converting the superfilled, two-sided MNW array to a one-sided MNW array.

5. The method of claim 2, comprising a further step, performed after the removing step, of:
electrodepositing additional metal to extend growth from the tips of the nanowires to make the MNW array thicker than the template membrane.

6. The method of claim 1, wherein: the template membrane comprises one or more of a ceramic template membrane and a polymer template membrane.

7. The method of claim 1, further comprising a step, performed after the removing step, of:
infiltrating the MNWs with an interstitial material to form a composite.

8. The method of claim 7, wherein the interstitial material comprises one or more of a phase change material (PCM) and a polymer.

9. The method of claim 1, further comprising an additional step, performed after the removing step, of applying a post-growth treatment to the MNW array.

10. The method of claim 9, wherein the post-growth treatment comprises applying to the MNWs one or more of a protective anti-oxidation coating and a protecting anti-oxidation film.

11. The method of claim 10, wherein the anti-oxidation coating comprises one or more of nickel, cobalt, platinum, rhodium, palladium, iridium, another noble metal, and a protective oxide.

12. A method for making a thermal interface material (TIM), comprising the steps of:
depositing a seed layer onto a sacrificial porous template membrane;
thickening the seed layer;
depositing metal into one or more of the pores of the template membrane, substantially filling the template membrane to create a vertically-aligned metal nanowire (MNW) array comprising a plurality of nanowires that grow upward from the seed layer; and
after the template membrane is substantially filled with the deposited metal, removing the template membrane, leaving the plurality of nanowires attached to the seed layer.

13. A method for making a thermal interface material (TIM), comprising the steps of:
depositing a seed layer that functions as a cathode onto a sacrificial porous template membrane;
attaching a sacrificial porous template membrane to the substrate;
electrodepositing metal into one or more of the pores of the template membrane, substantially filling the template membrane to create a vertically-aligned metal nanowire (MNW) array comprising a plurality of nanowires that grow upward from the seed layer;
electrodepositing additional metal to extend growth from the tips of the nanowires to make the MNW array thicker than the template membrane; and
after the template membrane is substantially filled with the electrodeposited metal, removing the template membrane, leaving the plurality of nanowires attached to the seed layer.

14. The method of claim 13, wherein the plating solution comprises an electrolyte configured to prevent one or more of bulk movement and convective motion of the plating solution.

15. A method for making a thermal interface material (TIM), comprising the steps of:
depositing a seed layer that functions as a cathode onto a sacrificial porous template membrane;
thickening the seed layer;
electrodepositing metal into one or more of the pores of the template membrane, substantially filling the template membrane to create a vertically-aligned metal nanowire (MNW) array comprising a plurality of nanowires that grow upward from the seed layer;
electrodepositing additional metal to extend growth from the tips of the nanowires to make the MNW array thicker than the template membrane; and
after the template membrane is substantially filled with the electrodeposited metal, removing the template membrane, leaving the plurality of nanowires attached to the seed layer.

16. A thermal interface material (TIM) comprising:
a vertically-aligned metal nanowire (MNW) array comprising a plurality of nanowires that grow upward from a seed layer deposited onto a template membrane using a vat comprising a growing medium, and the template membrane being removed after MNW growth.

17. The TIM of claim 16, wherein the growing medium comprises one or more of a plating solution, an electroless solution, and an ionic liquid.

18. The TIM of claim 16, wherein the vat comprises one or more of an electrochemical vat and an electroless vat.

19. The TIM of claim 16, further comprising an interstitial material with which the MNWs are infiltrated to form a composite.

20. The TIM of claim 19, wherein the interstitial material comprises one or more of a phase change material (PCM) and a polymer.

21. The TIM of claim 16, further comprising a protective anti-oxidation coating added after removal of the template membrane.

22. The TIM of claim 21, wherein the anti-oxidation coating comprises one or more of nickel, cobalt, platinum, rhodium, palladium, iridium, and another noble metal.

23. The TIM of claim 16, further comprising additional metal electrodeposited to extend growth from the tips of the nanowires to make the MNW array thicker than the template membrane.

24. The TIM of claim 18, wherein the vat comprises an electrochemical vat, and wherein the electrochemical vat comprises a plating solution, and wherein the plating solution comprises an electrolyte configured to prevent one or more of bulk movement and convective motion of the plating solution.

25. The TIM of claim 24, wherein the electrolyte comprises one or more of a gel electrolyte and a simple liquid ionized salt solution with dissolved ions.
